(19) United States
(12) Patent Application Publication
(10) Pub. No.: US 2025/0025997 A1
(43) Pub. Date: Jan. 23, 2025

(54) DIVERSIFIED CRAFTSMAN EQUIPMENT WITH TOKEN-COMPATIBLE CRAFTSMAN DEVICES

(71) Applicant: WÜRTH INTERNATIONAL AG, Chur (CH)

(72) Inventors: Heiko ROSSKAMP, Adelberg (DE); Adrien MARQUETTE, Schwäbisch Hall (DE); Louisa ASCHOFF, Neuenstein (DE)

(21) Appl. No.: 18/687,789

(22) PCT Filed: Jul. 28, 2022
(86) PCT No.: PCT/EP2022/071164

§ 371 Date: Feb. 28, 2024

(30) Foreign Application Priority Data
Aug. 31, 2021 (EP) 21290055.9

(51) Int. Cl. B25F 5/00; G06F 21/10

(52) U.S. Cl. CPC B25F 5/00; G06F 21/1014

(57) ABSTRACT

Craftsman equipment comprising a plurality of craftsman devices, at least some of which comprise mechanical receiving means for mechanically coupling with mechanical coupling means of a token, and the token having a processor and having the mechanical coupling means for selectively mechanically coupling to a respective mechanical receiving means of the respective craftsman device, the craftsman devices comprising at least two different elements from a group consisting of a electrical hand-held device, a tool or tool set, a storage system, a consumable, and a vehicle.

### CROSS-REFERENCE TO RELATED APPLICATION

This application is a national stage application, filed under 35 U.S.C. § 371, of International Patent Application No. PCT/EP2022/071164, filed on Jul. 28, 2022, claiming priority of the European patent application EP 21 290 055.9 filed on Aug. 31, 2021, all of them being incorporated by reference herein in its entirety.

### FIELD OF INVENTION

The invention relates to a craftsman equipment and a method for user-related management of craftsman devices by means of a token of a craftsman equipment.

### ART BACKGROUND

Conventional hand-held devices are controlled directly by a user. For example, a drill is controlled by a user inserting a suitable drill bit into the drill and then pressing an actuation button on the drill. If a user without specialist knowledge performs a delicate manual task using such a hand-held device, this can lead to incorrect operation, an undesirable result and a risk to operational safety.

DE 10258900 A1 discloses a cordless screwdriver for tightening screw components, with a screwdriver motor which is supplied with electrical voltage from a self-sufficient power supply arranged on the cordless screwdriver, at least three measuring devices which are provided for monitoring screwdriving parameters during the screwdriving process, namely a torque sensor, with which the tightening torque generated by the screwdriver motor can be measured, a rotation angle sensor, with which the current screw-in angle can be measured starting from a predetermined measuring position, and a current sensor, with which the drive current of the screwdriver motor can be measured. Furthermore, monitoring electronics are provided which switch off the screwdriver motor if the tightening torque, the screw-in angle and the drive current are all within a predetermined, assigned target parameter window.

Conventional hand-held devices reach their limits, especially when it comes to difficult or unusual processing tasks using a hand-held device.

### SUMMARY OF THE INVENTION

There is a need of the present invention to enable operation of a hand-held device in a simple, safe and error-resistant manner.

This need is met by the objects with the features according to the independent patent claims. Further embodiments are shown in the dependent claims.

According to an embodiment of the present invention, a craftsman equipment is provided comprising a plurality of craftsman devices, at least some of which comprise a mechanical receiving means for mechanically coupling with a mechanical coupling means of a token, and the token comprising a processor and the mechanical coupling means for selectively mechanically coupling with a respective mechanical receiving means of the respective craftsman device, wherein the craftsman devices comprise at least two different elements from a group consisting of the following elements: An electrical craftsman device; a tool or tool set; a storage system; a consumable; and a vehicle.

According to a further embodiment of the invention, there is provided a method for user-related management of craftsman devices by means of a token of a craftsman equipment having the features described above, the method comprising mechanically coupling the mechanical coupling means of the token to a mechanical receiving means of a selected one of the craftsman devices, and, after mechanical coupling has taken place, controlling the coupled craftsman device by means of the processor of the token.

In the context of the present application, a “token” can be understood in particular as a recognition token that can form a functional coupling between the token and a craftsman device. Such an identification token can be used in a coupled system, which can comprise the token, a craftsman device mechanically coupled thereto and optionally one or more other devices or nodes. In particular, a token may be a hardware component for identifying and/or authenticating a user to whom the token may be assigned. A token may be an electronic token and may, for example, provide a processor-related control, monitoring and/or communication function.

In the context of the present application, a “craftsman device” can be understood in particular as a device that is used by a craftsman during a manual activity. In particular, this may be an electric hand-held device (such as a cordless screwdriver), a (particularly non-electric) tool (for example a hammer, pliers, file, screwdriver or drill) or a tool set with several tools or tool elements (for example a drill box with drills or a bit box with bits), a storage system (for example, a toolbox), consumables (for example, bolt anchors or a box of screws), and/or a vehicle (for example, a motor vehicle in which a craftsman can transport his equipment to a work site, a forklift or a tool cart) and/or other craftsman's equipment (for example, a ladder). A craftsman device can also be a battery pack or an adapter between a battery pack and a processing device (for example, a drill module of a drill). For example, a token can be inserted into such a battery pack or such an adapter.

In the context of the present application, a “hand-held device” can be understood in particular as a portable device that can be operated and carried manually by a user and with which a manual task can be performed, for example working on a surface. Advantageously, the hand-held device can be an electric hand-held device that can be operated by means of an electrically generated driving force. Such an electric hand-held device can be controlled by means of electrical control signals-in particular provided by means of a token. In particular, a hole can be drilled in a substrate and/or a driving force in the form of a longitudinal force and/or a torque can be applied to a fastening element to be set in a substrate by means of a hand-held device and by applying a driving force in the form of a longitudinal force and/or a torque. For example, the hand-held device can be configured to rotate a machining device and thus a drill and/or a fastening element. Examples of electric or motorized hand-held devices are a cordless screwdriver, a cordless drill driver, a rotary screwdriver, a pulse screwdriver, a ratchet screwdriver, a drill, an impact screwdriver (in particular a cordless impact screwdriver) and a hammer drill.

In the context of the present application, a “craftsman's equipment” may be understood in particular as a set comprising a plurality of craftsman devices which a craftsman uses in combination to perform craftsman's tasks. For example, a craftsman's equipment may comprise at least ten, in particular at least one hundred, craftsman devices.

In the context of this application, the term “processor” can be understood in particular to mean an electronic entity which can contain an arithmetic unit and/or a control unit and/or can be configured for data processing. In particular, such a processor can have a controlling effect on a craftsman device mechanically coupled to the token and thereby set an operation or an operating mode of the craftsman device (in particular a hand-held device). In particular, the processor can control the setting of the operation or mode of operation of the craftsman device or a part thereof, in particular based on a user profile of a user of the token. The control logic between the token and the craftsman device and/or between the token and another node (in particular a further node or a central control device) can, for example, take place according to a master-slave architecture or according to a peer-to-peer architecture. The processor of the token can alternatively or additionally take on other functions, for example evaluating sensor signals from a sensor of the token, controlling communication with another node via a communication network, etc. A processor can, for example, be realized by a processor component, a plurality of processor components or a part of a processor component.

In the context of the present application, a “mechanical receiving means of a craftsman device” can be understood in particular as a structural device on a craftsman device which is configured geometrically and preferably also in terms of communication technology to a mechanical coupling means of a token which is to be mechanically coupled to the mechanical receiving means. For example, the mechanical receiving means can be a holding opening that is configured to hold a token or a part thereof in a form-fit and/or friction-fit manner. Advantageously, the mechanical receiving means of the craftsman device and the mechanical coupling means of the token can be adapted to each other in such a way that when a mechanical coupling is formed between the mechanical coupling means of the token and the mechanical receiving means of the craftsman device, a communication connection or a control connection is also formed simultaneously between the token and the receiving means. For example, the formation of a positive connection between the mechanical receiving means and the mechanical coupling means can simultaneously lead to the formation of an electrically conductive coupling between the token and the craftsman device, for example by forming a connection between electrical contacts of the token and the craftsman device. Electrical control signals can then be transmitted from the token to the craftsman device via such electrical contacts. It is also possible that by forming a mechanical connection between the mechanical receiving means and the mechanical coupling means, a contactless transponder (for example an RFID tag) of the token is brought into a readability distance of a transponder reader (for example an RFID reader) of the craftsman's device, so that control signals can then be transmitted wirelessly from the token to the craftsman's device.

In the context of the present application, a “tool” can be understood in particular as a hand-held device (for example a hammer, a pair of pliers, a file, a screwdriver or a chisel) or a machining tool (for example a drill, a bit or a milling cutter) inserted or to be inserted in an electrical hand-held device (for example in a machine tool). A tool can preferably be non-electric. However, a tool can be inserted into an electric hand-held device.

In the context of the present application, a “tool set” can be understood in particular as an arrangement of several tools or tool elements, in particular of the same tool type. In such a tool set, the several tools or tool elements can be accommodated in a common tool receiving means. For example, a tool set can be a drill box with several different drills or a bit box with several different bits.

In the context of the present application, a “storage system” can be understood in particular as a device or an arrangement of devices for holding a large number of electrical hand-held devices, tools and/or tool sets, consumables, etc. In particular, such a storage system can be configured as a shelf, case, drawer, etc.

In the context of the present application, “consumables” can be understood to mean, in particular, parts which can be arranged individually or as a group of jointly packaged parts in a common package and which are consumed by a craftsman during a craft activity and are therefore continuously replenished. Such consumables may be, for example, screws, dowels, nails, bolt anchors and the like, which are often stored as a group in a common package, in particular if the consumables are configured as C-parts.

In the context of the present application, a “vehicle” can be understood in particular as a device that can be moved, in particular on wheels, and that can be moved as intended by applying a driving force. In particular, a vehicle can be a motorized vehicle, for example moved by means of an electric motor and/or an internal combustion engine. Examples include passenger cars, trucks, construction site vehicles (e.g. excavators), forklift trucks, etc. Alternatively, a vehicle can be moved by muscle power, for example a workshop trolley to be pushed by a user.

In the context of the present application, the term “at least two different elements from a group consisting of a electrical hand-held device, a tool or tool set, a storage system, a consumable, and a vehicle” can be understood in particular to mean that of the five elements “electrical hand-held device” (A), “tool or tool set” (B), “storage system” (C), “consumable” (D) and “vehicle” (E), at least two different elements are contained in the craftsman's equipment. In particular, this includes the configurations A+B and optionally C and/or D and/or E, A+C and optionally A and/or D and/or E, A+D and optionally B and/or C and/or E, A+E and optionally B and/or C and/or D, B+C and optionally A and/or D and/or E, B+D and optionally A and/or C and/or E, B+E and optionally A and/or C and/or D, C+D and optionally A and/or B and/or E, C+E and optionally A and/or B and/or D, and D+E and optionally A and/or B and/or C. In addition, at least one further element (for example auxiliary accessories such as ladders, scaffolding) can optionally be part of the craftsman's equipment.

According to an exemplary embodiment of the invention, a craftsman equipment is created in which several different craftsman devices of high variety or diversification can each be mechanically coupled with a token, whereby the formation of such a mechanical coupling can be carried out with a mechanical receiving means of the craftsman device or a corresponding mechanical coupling means of the token. With a universally applicable token, which can be detachably coupled to any craftsman device, any craftsman device can be optionally equipped with a token function in a user-defined manner. For example, a token with a processor resource can be mechanically coupled to a handheld electrical device in order to control the handheld electrical device using the token's processor. For example, the electric hand-held device can be controlled by means of the token's processor in accordance with an authorization profile of a user of the token, whereby a user-specific use of an electric hand-held device can be enabled, disabled or adapted in a user-specific manner. Alternatively or additionally, it is also possible to use a token with a processor resource to track the spatial position of a hand-held device mechanically coupled to the token. This makes it possible, for example, to find misplaced or lost tools or consumables using the token. For this purpose, a token can be configured with a tracking function or coupled with a tracker, for example. It is also possible to mechanically couple a craftsman device with a token for the purpose of communicatively coupling the craftsman device in a communication network by means of the token, for example to communicate with a node in the communication network by means of the token. A communicable connection of a token to a communication network can also make it possible, for example, to trigger a reordering of consumables in a storage system via the communication network if the remaining stock has fallen below a critical value. A token that can be used universally due to its mechanical coupling means and its processor resource can be reversibly coupled with any one of a plurality of craftsman devices of a complex craftsman equipment via a universal mechanical interface in the form of their mechanical receiving means in order to equip a respective craftsman device with a token functionality.

Additional exemplary embodiments of the craftsman's equipment and the process are described below.

According to an exemplary embodiment, the craftsman equipment can have at least one further token with a further processor and with a mechanical coupling means for selective mechanical coupling with a respective mechanical receiving means of a respective other craftsman device. For example, each of a plurality of craftsman devices of a craftsman equipment can be provided with an associated token. Advantageously, each of the tokens may be provided with a processor which may be configured according to a function of the respective token. Advantageously, according to an exemplary embodiment of the invention, a set of tokens (each with processor resource) is provided for a craftsman equipment with very different types of craftsman devices, wherein each of the tokens can provide a specific function in relation to the respective associated craftsman device by merely forming a mechanical coupling with a respective craftsman device. This creates a modular system that can be scaled as required and provides control and/or monitoring functions in a powerful manner.

According to an exemplary embodiment, the token can have a communication means and the at least one further token can have a further communication means. Furthermore, the tokens can be communicatively coupled to each other by means of both communication means, in particular directly or via a node of a communication network. Different tokens, which are assigned to different craftsman devices, can therefore be communicatively coupled with each other. For example, the communicable coupling of a first token, which is attached to an electrical hand-held device that must be used with protective work equipment, with a second token, which is attached to said protective work equipment, enables the first token to recognize the use of the protective work equipment by a user based on its communication with the second token.

According to an exemplary embodiment, the token can be configured to control said craftsman device by means of the processor when the mechanical coupling means is mechanically coupled to the mechanical receiving means of the respective craftsman device. In the context of the present application, a “mechanical coupling means” can be understood in particular as a physical structure of the token which can be coupled, for example, positively and/or frictionally to a corresponding physical structure of a craftsman device in order to thereby form a temporary and well-defined mechanical connection between the token and the craftsman device. For example, the token can be inserted into a correspondingly shaped receiving opening of the craftsman device in order to mechanically couple the token and the craftsman device. In this case, the mechanical coupling means can be configured to create a communicable coupling between the token and the hand-held device by forming a mechanical coupling with a craftsman device. The formation of a mechanical coupling between a craftsman device and a token can be interpreted by the token's processor as a user request to operate the craftsman device and can trigger a comparison of a personalized user profile of the user with the mechanically coupled craftsman device. This trigger logic allows the authorization comparison to be carried out very quickly and the use of the craftsman device to be enabled by the user if the personalized user profile permits this.

According to an exemplary embodiment, the token can be configured as a disk, in particular as a circular disk, with a diameter in a range from 1 cm to 10 cm, in particular in a range from 2 cm to 5 cm. It is also possible for the token to be configured as a cuboid (in particular a flat cuboid) with an edge length in the range from 1 cm to 10 cm, in particular in the range from 2 cm to 5 cm. A token formed as a small disk can be conveniently carried by a user and allows the formation of a mechanical coupling with a craftsman device in a space-saving manner. In addition, the formation of the token as a circular disk with the aforementioned dimensions allows the implementation of a sensor identifying a user of the token, in particular a fingerprint sensor, on a surface of the token. For self-identification, which may be a prerequisite for the formation of a controllable coupling between the token and the craftsman device, it may be sufficient for a user to identify themselves by placing a finger on the fingerprint sensor. After successful identification, the authorization of the identified user to control the craftsman device coupled with the token can then be checked in the token. If the check is successful, control can be started; if the check is unsuccessful, control can be stopped.

According to an exemplary embodiment, the mechanical coupling means can be configured to be able to remove the token from the craftsman device again after mechanical coupling. In this way, a user who wishes to use a craftsman device can mechanically couple a token assigned to him to the craftsman device and remove the token from the craftsman device again after use has ended. The craftsman device can be configured to allow control of the craftsman device by the token or even use of the craftsman device only during the existence of a mechanical coupling with a token.

According to an exemplary embodiment, the mechanical coupling means can have an electromechanical interface, in particular an electromechanical interface that is universal for different craftsman devices. An electromechanical interface can be understood here to mean that the formation of a mechanical connection between the mechanical coupling means of the token and a corresponding mechanical receiving or connecting means of the craftsman device simultaneously leads to the formation of an electrical coupling between the token and the craftsman device. A positive coupling of the token and the craftsman device, for example, can then also enable the transmission of an electrical control signal from an electrical contact of the token to an electrical contact of the craftsman device. This type of craftsman equipment is particularly robust in operation.

According to an exemplary embodiment, the token can be configured to form a communication connection, in particular a contactless or contact-based communication connection, with the craftsman's appliance when the mechanical coupling means is mechanically coupled to a craftsman's appliance. With reference to the exemplary embodiment described above concerning an electromechanical coupling between token and craftsman device, contact-based electrical communication between token and craftsman device can preferably only be enabled when the mechanical connection is formed. This allows a user to retain control sovereignty through an intuitive connection process. Alternatively, a contactless communication link between the token and the craftsman device can only be established by forming a mechanical coupling between the token and the craftsman device. For example, a wireless transponder (e.g. an RFID tag) of the token can only be brought into a readable distance of a transponder reader (e.g. an RFID reader) of the craftsman device by inserting the token into the craftsman device. This can be achieved, for example, by using a short-range communication protocol (e.g. NFC, near field communication) for wireless communication between the token and the craftsman's device.

According to an exemplary embodiment, the token can have a communication means that is configured to communicate by means of a communication network, in particular by means of the public Internet, by means of an intranet and/or by means of a mobile communications network. In particular, the token can be configured for cryptographic communication using a cryptographic unit of the token. Such a communication means may include, for example, a transmit and/or receive antenna and an associated processor resource, which enable, for example, wireless communication in accordance with a communication protocol of the communication network with one or more other nodes of such a communication network. In this way, the token can communicate unidirectionally or bidirectionally with one or more other nodes beyond the control of a craftsman device mechanically coupled to it, for example to download (download) and/or upload (upload) information. For example, a download of information from a communicatively coupled node to the token may include a download of a user profile or a flow control processing task to be performed by a user using a craftsman device mechanically coupled to the token. For example, an upload of information from the token to a communicably coupled node may include an upload of tracking data that enables tracking of an operation of the token and/or a craftsman device coupled thereto for documentation and/or quality monitoring purposes.

According to an exemplary embodiment, the token can be configured to communicate by means of the communication means with at least one communicably coupled node of the communication network, which is selected from a group consisting of another token, a portable user terminal with an app stored thereon (which can be configured to communicate with a token), a central control device (for example for centrally managing or controlling craftsman devices of a craftsman equipment), and a reordering device for reordering consumables for operating a craftsman device. According to one embodiment, several tokens can communicate with each other. For example, a first token can be mechanically coupled to a first craftsman device (for example, a hand-held device such as a hammer drill) and a second token can be mechanically coupled to a second craftsman device (for example, protective work equipment such as safety goggles). If, for example, the use of protective work equipment is prescribed for the operation of the hand-held device, the commissioning of the hand-held device can be made dependent on communication between the two associated tokens documenting that the user of the hand-held device associated with the first token is wearing the protective work equipment associated with the second token. However, it is also possible for a user to control a craftsman device from a portable user terminal (e.g. a cell phone) equipped with appropriate software and thus from a remote location. For this purpose, the user terminal and the token can communicate with each other via a communication network. If necessary, the token can also use resources of the user terminal device, for example a camera resource, to control the craftsman device. Furthermore, it is possible for a central control device to control a large number of decentralized craftsman devices, for example in the sense of user profiles, which enable individual users of the decentralized craftsman devices to use certain craftsman devices in a user-specific manner. In other words, user profiles of users can be stored on a central control device. If a token mechanically coupled to a craftsman device wishes to allow use of the craftsman device by a user identified by the token, the token can gain access to the user profile of the associated user by communicating with the central control device and only allow use of the craftsman device by that user if the use of the craftsman device by the identified user is in accordance with the user profile. For example, the use of a chainsaw can be made dependent on a user's corresponding qualification or instruction, which is reflected in the user profile. In addition, it may also be possible for a token mechanically coupled to a craftsman device to recognize a need to reorder consumables and transmit it to a communicatively coupled reordering device. For example, such a token can be mechanically coupled to a container holding consumables and can recognize the successive removal of consumables from this container (for example by sensors). For example, when a remaining stock of consumables falls below a predefined threshold value, a reorder can then be triggered by the token, namely by direct or indirect communication between the token and the reordering device.

According to an exemplary embodiment, the token can be configured to download a data set from a communicatively coupled node of the communication network by means of the communication means, in particular a data set defining an operating sequence of the craftsman device and/or a data set defining a user profile of a user of the token. A communicable coupling can, for example, be wired (for example, electrically via at least one electrical line or optically via an optical fiber) or wireless (for example, by transmitting electromagnetic radiation, such as visible light, infrared light or high-frequency radiation). The aforementioned and/or other data can be stored at a central location of the communication network, for example at a central control device for controlling or managing a plurality of craftsman devices, and thus with an overall efficient use of resources. If necessary, a decentralized token-for example, mechanically coupled to a craftsman device-can retrieve the data from the central control device or another node via the communication network. By retrieving a data set defining an operating sequence of the craftsman device, the token can receive control information for controlling the craftsman device accordingly to carry out said operating sequence and subsequently control the craftsman device accordingly. For example, setting a fastener (e.g. a screw) in a substrate may require the application of a certain torque, the magnitude of which the token can retrieve via the communication network. It is also possible that a user identified by means of the token is subject to certain restrictions regarding the use of a craftsman device mechanically coupled to the token, so that the use of a craftsman device by a particular user is only permitted by the token in accordance with a corresponding user profile that the token can download via the communication network.

According to an exemplary embodiment, the token can be configured to upload a data set to a communicatively coupled node of the communication network by means of the communication means, in particular a data set containing operating results and/or operating parameters of an operation of the craftsman device. For example, a processing task (e.g. setting a fastening element in a substrate) carried out by a craftsman device can be documented in the form of a data record and transmitted as operating results to a node of the communication network (e.g. a central management or control device). This allows subsequent tracking for documentation and/or quality assurance purposes. For example, the actual torque applied by a cordless screwdriver when screwing in a screw can be transmitted as an operating parameter in connection with the processing of a machining task.

According to an exemplary embodiment, the processor may be configured to control the operation of the craftsman device coupled to the token in accordance with a personalized user profile stored in the token or accessible to the token, in particular in accordance with a personalized user authorization profile, of the user of the token. In the context of the present application, a “personalized authorization profile of a user in relation to a craftsman device” can be understood in particular as a data set relating specifically to a user, which grants this user specific usage rights (for example, the right to use a hand-held device) in the context of the use and/or management of specific craftsman devices of a craftsman device equipment, if the user has received appropriate instruction or has a corresponding driver's license), usage restrictions (for example, the right to use only a hand-held device that does not exceed a certain maximum weight or if the user is wearing associated protective work equipment) and/or usage prohibitions (for example, the prohibition to use a hand-held device if the user has not received appropriate instruction or does not have a corresponding driver's license). A specific assignment of authorizations, authorization restrictions and/or authorization prohibitions to specific craftsman devices can be made in the authorization profile.

According to an exemplary embodiment of the invention, the processor can be configured to allow, set and/or prevent use of the craftsman device by the user based on the personalized authorization profile when coupled with a respective craftsman device. According to an exemplary embodiment of the invention, a token can control a craftsman device mechanically coupled to it in a user-specific or user-related manner. For example, triggered by the formation of a mechanical coupling between the token and the craftsman device, use of the craftsman device by the user can then be granted or an access right can be denied or the manner of use can be regulated in accordance with the personalized user profile. By assigning a user-related authorization profile to individual craftsman devices of a craftsman equipment, even in complex systems with a large number of craftsman devices, tokens and users, a fast and error-resistant comparison between user profiles and craftsman devices can be carried out by means of a user-related token in particular, thus achieving efficient access management. At the same time, a high degree of operational security can be achieved, as the administration of authorizations is efficiently possible even with a confusingly large number of craftsman devices, users and tokens.

According to an exemplary embodiment, the token may comprise an identification means for identifying a user of the token. In the context of the present application, an “identification means for identifying a user of the token” can be understood in particular as an entity or a function block of the token which provides information for determining the identity of the user of the token. An identification means can carry out the identification of a user, for example, using sensor data indicative of a user identity (such as sensor data from a fingerprint sensor) and/or by means of a corresponding user input (for example, entering a user ID, optionally in combination with a password). As part of the identification of a user, the identification means can in particular perform a comparison between determined sensor data (e.g. actual fingerprint data) and predetermined reference data (e.g. target fingerprint data).

According to an exemplary embodiment, the processor can be configured to enable operation of the craftsman device coupled with the token only if a user identification carried out in advance by means of the token has led to the result that an identifying user is authorized to operate the craftsman device. According to an exemplary embodiment, operation of the craftsman device can be prevented without coupling with the token. Without positive verification of a user's authorization to use a particular craftsman device, use of the craftsman device may be disabled. If a user presses an operating button of a drill without or before verification of the user authorization, the processor of the token disables the drilling operation of the drill. The need for a positive confirmation of the user authorization of a craftsman device by a user increases operational safety and prevents misuse.

According to an exemplary embodiment, the craftsman devices can have at least one electric or motorized hand-held device. This can, for example, be formed from a group consisting of a drill, a cordless screwdriver, a cordless drill driver, a rotary screwdriver, a pulse screwdriver, a ratchet screwdriver, an impact screwdriver, in particular a cordless impact screwdriver, a hammer drill, a corded hand-held device and a compressed air-driven hand-held device.

According to an exemplary embodiment, the tool can be configured as a tool from a group consisting of a hammer, pliers, a file, a screwdriver, a drill, a bit and a nut for a ratchet. A tool set can, for example, be a bit holder with bits held in it or a drill holder with drills held in it.

According to an exemplary embodiment, the storage system can be configured as a storage system from a group consisting of a case, a shelf, a drawer and a box.

According to an exemplary embodiment, the consumable may be formed as a consumable from a group consisting of a screw, a dowel, a bolt anchor, a nail, a rivet, and a package containing such consumables.

According to an exemplary embodiment, the vehicle can be configured as a vehicle from a group consisting of a vehicle driven by a motor (in particular electrically and/or by means of an internal combustion engine) and a vehicle driven by muscle power (for example a tool trolley).

According to an exemplary embodiment, the craftsman devices may comprise at least one electrical hand-held device, at least one tool and/or at least one tool set, at least one storage system, at least one consumable, and at least one vehicle.

### BRIEF DESCRIPTION OF THE DRAWINGS

In the following, exemplary embodiments of the present invention are described in detail with reference to the following figures.

FIG. 1 shows a craftsman equipment with craftsman devices and tokens according to an exemplary embodiment of the invention, which are coupled in a communication network with additional communicable nodes.

FIG. 2 shows a token with an associated storage and recharging device according to an exemplary embodiment of the invention.

FIG. 3 shows a token according to an exemplary embodiment of the invention.

FIG. 4 shows components of a craftsman's equipment according to another exemplary embodiment of the invention.

FIG. 5 shows a craftsman equipment with craftsman devices and a token according to an exemplary embodiment of the invention, which are coupled in a communication network.

### DETAILED DESCRIPTION

Identical or similar components in different figures are marked with the same reference numbers.

Before exemplary embodiments of the invention are described with reference to the figures, some general aspects of embodiments of the invention will be explained.

According to an exemplary embodiment, a token can be used for use with a craftsman device (for example, a machine tool).

For example, the token can be provided with a combined electrical and mechanical structure. More precisely, different tokens of a token arrangement can have a common basic electrical and/or mechanical structure, but can also differ in terms of a variable additional electrical and/or mechanical structure. As fixed constituents, different tokens of a token arrangement can have a processor (which can, for example, also perform post-processing and/or data compression tasks), a communication means and a cryptographic unit (in particular a decrypter). A variable proportion of different tokens in a token arrangement may, for example, have differences with regard to at least one transmit/receive unit, at least one antenna and/or at least one sensor. A respective token may be formed as an object that may have a packaging component, one or more slots, compatibility with a battery, and/or a conductor adapter. It is also possible for a token to be supplied with electrical power from an external source. According to an exemplary embodiment, a token system can perform (in particular indirect) control of a craftsman device using an authorization concept, in particular using a personalized authorization concept.

Tokens in a token arrangement can have different degrees of functionality and can therefore be assigned to different generations. For example, a token with a first level of functionality can be equipped with limited sensors (e.g. only a temperature sensor and a vibration sensor) in terms of processing and communication as a BLE-capable token. Such a token can be used, for example, to download data sheets from a central node of a communication network. The execution of a processing task using a craftsman device assigned to a token can be made dependent on a current ambient temperature, for example. For example, the setting of a chemical dowel can only be permitted if a minimum processing temperature is ensured. A second-generation token can, for example, be configured as an ultra-wideband token in terms of processing or communication, which can also be equipped with a gyro sensor. For example, such a gyro sensor can detect when a hand-held device (such as a drill) falls to the ground and can then automatically switch off the hand-held device. A third-generation token can also be equipped with NB IoT (Narrow Band Internet of Things) functionality and a GPS sensor. A third-generation token can therefore be able to determine the location of the token and a mechanically coupled craftsman device and only grant permission to operate the craftsman device if the determined location is approved for the intended operation of the craftsman device. For example, the commissioning of an excavator can only be approved if the excavator is located on a specific construction site. This provides protection against misuse.

According to an exemplary embodiment of the invention, a token forms a basic unit of a system for the controlled operation of craftsman devices. Such a token can have a fixed component (in particular with microcontroller, decrypter), which can be contained in each token of a token arrangement. Furthermore, each token of a token arrangement can enable an electromechanical connection to craftsman devices (in particular, provide one or more electrical contacts for electrical coupling with a craftsman device). In addition, tokens of a token arrangement may have a variable portion, which may be different for different tokens. Such a variable portion may include equipping a token with one or more sensors (for example, fingerprint sensor, gyroscope, GPS sensor, UWB sensor, temperature sensor), at least one radio chip (for example, configured according to Bluetooth Low Energy, Bluetooth, NB-IoT, LTE Cat. M, 5G, NFC) and/or at least one antenna (for example configured according to 2.5 GPS, BLE, UWB, NB-IoT). Optionally, a token can be equipped with its own power supply, for example a battery or rechargeable battery.

One or more tokens with the described properties can form part of a system of craftsman equipment, which can also include craftsman devices (such as cordless drills, tools, cases, shelves, etc.). Software components (for example an IoT cloud software, an app, etc.) can also be part of such a system.

Preferably, a token according to an exemplary embodiment of the invention has a mechanical coupling means, which can be configured as an electromechanical coupling. This mechanical coupling means can be plugged onto or into electromechanical couplings of craftsman devices (such as hand-held devices, tools, cases, shelves, etc.). It is also possible to attach a mechanical coupling means of a token to or in a housing provided for this purpose (for example, a tracker) or to or in other devices (for example, a device for filling empty spray cans and the like).

During operation, a token can communicate with the craftsman device or other device into which the token is inserted. In this way, a token can determine on or in which object the token is inserted. A uniform bus is therefore advantageous for all objects. This ensures that in a complex system of a craftsman's equipment (for example a machine park or craftsman's equipment of a company) each token can be brought into mechanical and communicative connection (in particular control connection) with each craftsman's device. In more general terms, all of the craftsmen's devices in a craftsmen's equipment system can be equipped with a mechanically identical mechanical connection device, all of which enable optional coupling with the same token. In other words, the token can be plugged into all these items as a module.

According to an exemplary embodiment, a token can transmit documents and/or control signals to the craftsman device (for example, a cordless drill) into which the token has been inserted. Alternatively or additionally, it is possible for a token to download documents relating to an additional device (e.g. a tool, an adapter, etc.) connected to a hand-held device. A token can also download documents relating to a workpiece to be processed with a hand-held device (for example a concrete anchor) and thus control the hand-held device accordingly (for example controlling a speed for drilling and/or screwing in a concrete anchor).

Preferably, a token can download authorizations for a craftsman device (e.g. a hand-held device, tool, case, shelf, etc.) so that the craftsman device can only be operated in a specific spatial area (e.g. drilling machines only on a construction site). For example, a GPS sensor can be implemented in the token or associated craftsman device to provide up-to-date location information.

In particular, a token according to an exemplary embodiment of the invention can download authorizations for a craftsman device (for example, a hand-held device, tool, case, shelf, etc.) so that the craftsman device can only be used or operated by certain persons (for example, only instructed personnel). In particular, the token can download authorizations for the craftsman device so that the craftsman device can only be operated with certain personal protective equipment.

A token can control a mechanically coupled hand-held device, for example switching a vacuum cleaner on or off. For example, when a drill is switched on, the token can also trigger the switching on of a drill dust extractor, so that a user does not need another hand to switch on an associated vacuum cleaner.

According to an exemplary embodiment, a token can be equipped with an optical sensor (for example a camera or a laser scanner) to identify a product or a body (for example a wall or a screw) that is processed with a craftsman device.

It is also possible for the token to download product information about the product from a node in a communication network that is connected to it in a communicable manner. The token or a craftsman device mechanically coupled to it then knows how the product is to be processed, for example what torque is to be applied.

According to one embodiment of the invention, different types of hand-held devices (in particular electrical hand-held devices such as impact drills, tools or tool sets such as drills or drill boxes, storage systems such as shelves, consumables such as screw packs and/or vehicles such as forklift trucks) are mechanically coupled to a respective token (which has a processor). The token assigned to a respective craftsman device can also be exchanged between different craftsman devices in a removable manner and can therefore be used universally. Very different functions can be provided by means of the token's processor, such as controlling an assigned electrical hand-held device, communicable coupling between different hand-held devices by means of their tokens, communicable coupling of a token of a hand-held device with a communication node (for example for uploading and/or downloading data, or for triggering a reordering of consumables), or localization or spatial tracking of tokens together with the assigned hand-held device. The architecture described is particularly suitable for a diversified system of many craftsman devices of a craftsman equipment and enables their efficient management with little effort.

For example, the system described in accordance with an exemplary embodiment of the invention can be used to efficiently support a craftsman in performing a craftsman's task. For example, a craftsman may be faced with the task of inserting a concrete screw into a substrate using a cordless screwdriver. For this purpose, a user can first be identified using a token on the cordless screwdriver and it can be checked whether a personalized authorization profile of the identified user allows this user to use the cordless screwdriver. If this is positively verified, the type of screws or other consumables used, for example M8 screws, can be detected by a camera on the token, the cordless screwdriver or a mobile device connected to the token in a communicable manner. To assist the user in setting the detected consumable, the token of the cordless screwdriver can then be used to download a specification of a record operation from a database in a communication network and process it using the cordless screwdriver.

According to an exemplary embodiment of the invention, a craftsman equipment is managed as a working environment of a craftsman with several craftsman devices or other components, which may comprise, for example, electrical hand-held devices, tools, cases, shelves and the like. Each of these components or craftsman devices may have an electromechanical interface for a token. Similarly, a token may have an electromechanical interface for connection to the electromechanical interface of the craftsman devices or other components.

For example, the token can communicate with an assigned craftsman device or other component so that the token knows which craftsman device it is in. For example, the token can control the assigned craftsman device or other assigned component. It is also possible for the token to download documents from a communication network (such as the Internet or an intranet), for example as a basis for controlling the craftsman device or other component assigned to it. Advantageously, the token can be configured to be modularly interchangeable between different craftsman devices or components. It is also possible for the token to be controlled by the associated craftsman device or other component. To enable wireless communication, the token can be equipped with a wireless connection to the Internet or an intranet (in particular by providing a WLAN antenna, SIM card, etc.). Advantageously, the token can have a communication connection to one or more craftsman devices, in particular via a wireless or wired connection. Preferably, the token can be arranged in a modular, interchangeable manner in different craftsman devices. For this purpose, the token can be equipped with an electromechanical interface that is the same for all tokens and can therefore be flexibly coupled with a universal electromechanical interface of each craftsman device.

A token according to an exemplary embodiment of the invention can download documents from a communicatively coupled node and/or upload documents to a communicatively coupled node via a communication network.

According to a preferred exemplary embodiment, the token can load authorizations in a user system for craftsman devices and the like from a cloud and, if an authorization is missing or only limited for a user, block or restrict a craftsman device for this user.

According to exemplary embodiments, a token can be provided in different variants with different degrees of functionality. For example, a first-generation token can only support Bluetooth communication and have a temperature sensor and a vibration sensor in terms of its sensor technology. A second-generation token can also have NB-IoT functionality and its sensors can also include a gyroscope. Further functionality of a token is possible, for example a GPS sensor, a UWB module, a fingerprint sensor, etc.

For example, a token can be in communication with an app that is running on a user device, for example. This can make it possible, for example, to recognize a tool being used (such as a drill), for example by means of the user terminal's camera. A workpiece or consumable, such as a concrete anchor, can also be recognized in the same way. Based on the recognized information, the tool and consumable can be appropriately controlled and processed.

If a token is equipped with communication capability, it can be connected to a gateway, another token, etc. with communication capability.

A token according to an exemplary embodiment of the invention can also provide anti-theft protection. For this purpose, the token can, for example, be equipped with a fingerprint sensor, a facial recognition sensor or the like in order to identify a user. Only an authorized user can be granted access to use the assigned craftsman device. For example, a machine can only be operated with an appropriately authorized token.

An authorization for the token can be stored on the token and/or can be stored in a cloud. A token can download an authorization profile from a user and for machines for this user and for tools for machines. Furthermore, a token can store these authorizations locally after each download so that they are available offline. Authorizations can alternatively or additionally be stored in a machine or a battery. In this case, the user then identifies themselves on the machine and/or the battery.

Authorizations can also include user-specific data. For example, if a machine is too heavy for a user, this machine can be blocked for this user. According to one embodiment, a token can be inserted into a tracker. The tracker can be attached to a machine, for example by gluing, magnetically connecting or latching. The token is then inserted into the tracker. For example, the tracker can have a battery and antennas for RFID and/or WLAN and/or Bluetooth.

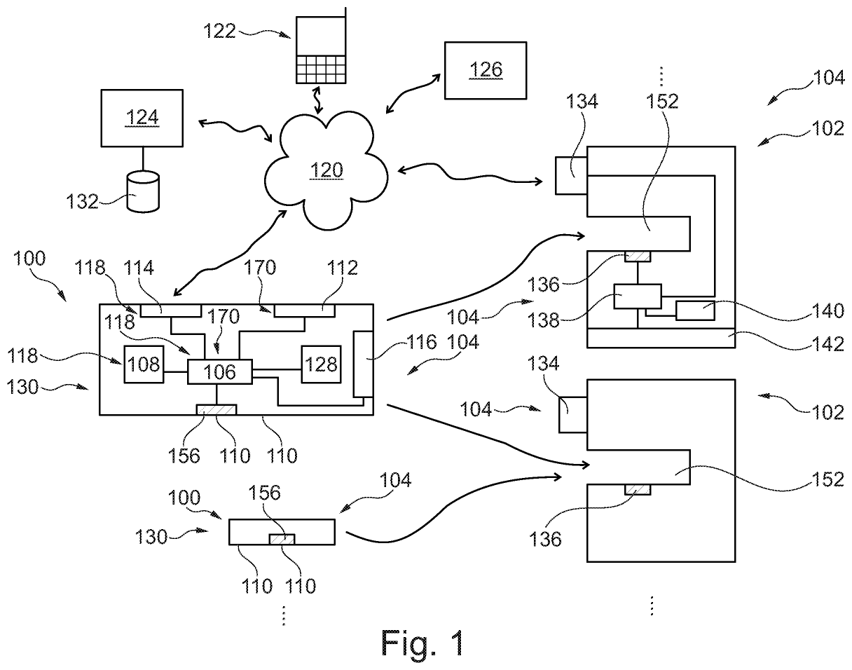

FIG. 1 shows a craftsman equipment 104, for example a workshop equipment or a machine park or craftsman equipment of a company, with craftsman devices 102 and tokens 100 according to an exemplary embodiment of the invention, which are coupled in a communication network 120.

More specifically, the craftsman equipment 104 comprises a plurality of tokens 100, which may, for example, all be shaped and dimensioned in the same way. In FIG. 1, only two such tokens 100 are shown, but a much larger number of tokens 100 is possible in a craftsman equipment 104 (for example at least ten, in particular at least one hundred).

In addition, a plurality of craftsman devices 102 is provided in the craftsman equipment 104. FIG. 1 shows only two such craftsman devices 102, but a much larger number of craftsman devices 102 is possible in a craftsman equipment 104 (for example at least ten, in particular at least one hundred). Some or all of the craftsman devices 102 may include an identically shaped and dimensioned mechanical receiving means 152, here formed as an insertion or receiving aperture configured to mechanically couple with a respective mechanical coupling means 110 of any user-selected one of the tokens 100. A positive connection can be formed between each mechanical coupling means 110 of each token 100 and each mechanical receiving means 152 of each craftsman device 102 by plugging them together.

When a mechanical connection is formed between a token 100 and a selected craftsman device 102 by inserting the mechanical coupling means 110 of the token 100 into the receiving means 152 of the selected craftsman device 102, an active or communication connection is simultaneously formed between the token 100 and the craftsman device 102. More specifically, in the illustrated exemplary embodiment, an electrical connection is formed between one or more electrical contacts 156 on an exterior of each token 100 and one or more electrical mating contacts 136 on an interior of each receiving means 152 of each craftsman device 102. The formation of a positive fit between a respective token 100 and a respective receiving means 152 of a craftsman device 102 thus leads to the formation of an electrical contact and thus an electrically conductive connection between the token 100 and this craftsman device 102. This electrical connection also forms an electrical communication connection between the token 100 and the craftsman device 102, which in particular enables the transmission of electrical signals (for example control signals). As an alternative to this contact-based electrical coupling, a wireless or contactless communication link can be formed between a token 100 and a craftsman device 102 by inserting the token 100 into the receiving means 152 to bring a transponder (for example, an RFID tag, not shown) of the token 100 within a readability distance of a transponder reader (for example, an RFID reader, not shown) of the craftsman device 102 (not shown).

Advantageously, a token 100, if it has been brought into communication with the craftsman device 102 by insertion into the receiving means 152 of a craftsman device 102, is configured to control this craftsman device 102. Operation of the craftsman device 102 in a state without coupling with the token 100 can be prevented. In other words, the use of the token 100 and the craftsman device 103 can only be enabled once the token 100 and the craftsman device 103 have been successfully coupled.

By allowing each token 100 to be selectively coupled to each mechanical receiving means 152 of a selected craftsman device 102, a flexibly combinable, modular system for operating, controlling and/or managing craftsman devices 102 in a complex craftsman equipment 100 is provided.

In FIG. 1, the craftsman devices 102 are only partially and only schematically shown. For example, a first part of the craftsman devices 102 may be configured as electric or motorized hand-held device, for example as electric drills, electric cordless screwdrivers, etc. Craftsman devices 102 configured as electric or motorized hand-held devices can, for example, have a functional device 134 which performs the actual function of the respective hand-held device and can be driven by means of an electric or motorized drive. In the case of a craftsman device 102 configured as a drill, the functional device 134 can, for example, be a drill chuck (in particular with a drill bit). In the case of a craftsman device 102 configured as a cordless screwdriver, the functional device 134 can be, for example, a bit holder (in particular with a bit). Furthermore, a hand-held device may have a power supply device 142, for example a removable and rechargeable battery pack. Such a power supply device 142 can supply the functional device 134 with electrical drive energy during operation. Alternatively or additionally, the power supply device 142 may also supply a token 100 with electrical power when the token 100 is received in the receiving means 152. A hand-held device may also include a control device 138, which may be configured to control the hand-held device (for example, when a hand-held device is not coupled to a token 100) and/or to interact with a processor 106 of a coupled token 100.

A second part (not shown) of the craftsman devices 102 may be formed as (in particular non-electric or non-motorized) tools or tool sets, for example as a screwdriver, drill or drill box, bit or bit box, etc.

A third part (not shown) of the craftsman device 102 can be configured as storage systems for storing hand-held devices, tools and consumables. Examples of such storage systems are boxes, cases, drawers and/or shelves for holding or storing hand-held devices, tools and/or consumables.

A fourth portion (not shown) of the craftsman devices 102 may be formed as a consumable, such as boxes of screws or dowels, or as a bolt anchor.

A fifth portion (not shown) of the craftsman devices 102 may be formed as motorized vehicles, for example, cars or trucks, forklifts and/or excavators, such as those used in performing hand tasks. Non-motorized vehicles driven by muscle power, such as a pushable tool trolley, can also be used.

A sixth portion (not shown) of the craftsman devices 102 may be formed as other tools and implements of the craftsman equipment 104, such as ladders, scaffolding, etc.

A portion or each of the described craftsman devices 102 may be temporarily or permanently equipped with a token 100.

Advantageously, the craftsman devices 102 for coupling with the tokens 100 are configured such that a use of a craftsman device 102 coupled with a token 100 can be allowed, set and/or prevented by a user based on a personalized authorization profile. More specifically, a user of a token 100 may be assigned a user profile that may include information with respect to an enablement and authorization of that user to use certain craftsman devices 102, but may also define usage restrictions and/or usage prohibitions with respect to certain craftsman devices 102. Such a user profile may be stored in a memory device 128 of a token 100, in a memory device 140 of a craftsman device 102 and/or in a database 132 of a node (in the illustrated exemplary embodiment a central control device 124, alternatively another node) communicably coupled to the token 100 via a communication network 120.

The structure of the token 100, which is shown in detail in FIG. 1, is described in more detail below as an example. Said token 100 is used, for example, for user-related control of a selectable one of the craftsman devices 102 of the craftsman equipment 104 and has a processor 106 for this purpose. For example, the processor 106 may be embedded inside the token 100 and thereby protected. The processor 106 may, for example, be in the form of a microprocessor. It is possible to form the processor 106 as part of a processor unit, as an entire processor unit or as a plurality of interacting processor units. The processor 106 of the token 100 is used for control-related interaction with different craftsman devices 102 of the craftsman equipment 104, and in particular interacts functionally with a selected craftsman device 102 into whose receiving means 152 the token 100 is inserted.

Furthermore, the token 100 includes a cryptographic unit 108 that supports cryptographic communication of the token 100. More specifically, the cryptographic unit 108 can be used to encrypt a communication of the token 100 with a communication partner device in the communication network 120. For example, such encrypted communication supported by the cryptographic unit 108 can take place between the token 100 on the one hand and a central control device 124, a user terminal 122 and/or a reordering device 126 on the other hand. Encrypted communication increases data security during communication via the communication network 120. Optionally, it is also possible to use the cryptographic unit 108 to carry out encrypted communication between the token 100 and a craftsman device 102 mechanically coupled to it, for example when transmitting control signals from the token 100 to a craftsman device 102 formed as a hand-held device. This leads to secure control of a respective craftsman device 102, since a hacker attack or unauthorized control from outside can be prevented as a result.

As already mentioned, the token 100 has the mechanical coupling means 110, which is configured for preferably positive mechanical coupling with a receiving means 152 of a respective one of different craftsman devices 102 of the craftsman equipment 104. The mechanical coupling means 110 of the token 100 is defined by its outer shape, which is shaped inversely to the inner shape of a receiving means 152 of a respective craftsman device 102.

Advantageously, when the mechanical coupling means 110 is mechanically coupled to a receiving means 152 of a selected craftsman device 102, the token 100 may be configured to control the operation of said craftsman device 102 by means of the processor 106 (and optionally the cryptographic unit 108 using cryptographic communication). More specifically, the processor 106 of the token 100 may control the craftsman device 102 and, in particular, its functional device 134 such that the desired processing task is performed by the craftsman device 102 as intended. For example, the processor 106 of the token 100 may specify the torque to be applied by a drill bit of a craftsman device 102 configured as a drill to a substrate in which a borehole is to be drilled.

Advantageously, the token 100 can be configured for user-related control of the craftsman device 102, in particular on the basis of a personalized authorization profile of the user. For this purpose, the token 100 can be provided with an identification means 170, which is configured to identify a user of the token 100. The identification means 170 is formed by a sensor 112, configured for example as a fingerprint sensor, and the part of the processor 106 that identifies the user from sensor data determined by means of the sensor 112, for example by pattern matching with reference data. More precisely, the sensor 112 is configured, for example, as a fingerprint sensor on which a user places a finger for identification. Advantageously, the sensor 112 can therefore be located in a surface area of the token 100. The sensor 112 can then determine whether the data recorded by the sensor 112 indicates that the user is an authorized or rightful user or which user it is. This determination can be made by comparing the sensor-detected data with sensor reference data (for example, a fingerprint of an authorized user stored in a database).

The aforementioned memory device 128 of the token 100 may store information indicative of, or providing access to, a personalized authorization profile of the user with respect to the craftsman device 102. More specifically, the memory device 128 of the token 100 may store a set of data representing or mapping an authorization profile of a user (or multiple authorization profiles of multiple users). However, it is also possible that the authorization profile of one or more users is stored in an entity remotely located with respect to the token 100, for example in a central database 132 of a central control device 124, through which the token 100 may be communicably coupled by means of the communication network 120. To access an authorization profile of a user, it may then be sufficient to store access information (for example, a link to the central database 132, possibly in combination with a password) in the token 100 to access the remotely stored authorization profile.

The processor 106 may be configured to control the operation of the craftsman device 102 coupled to the token 100 in accordance with the user authorization profile of the user of the token 100. In particular, the processor 106 may be configured to enable the operation of the craftsman device 102 coupled to the token 100 only if a user identification performed in advance by means of the token 100 has led to the result that an identifying user is authorized to operate the craftsman device 102. Advantageously, the processor 106 of the token 100 can thus be configured to allow, set and/or prevent use of the craftsman device 102 by the user based on the personalized authorization profile when coupled to the craftsman device 102. For example, a processing task desired by a user using a craftsman device 102 may only be permitted for certain users, for example if the user has received specific instruction or has received a special qualification (for example a driver's license) to use the craftsman device 102. If the authorization profile of the user does not meet such a condition, the use of the craftsman device 102 can be prevented by the processor 106 of the token 100. However, if the authorization profile of the user meets such a condition, the use of the craftsman device 102 can be allowed by the processor 106 of the token 100. If certain processing tasks are only permitted to a limited extent for a user due to an authorization profile, the use of the craftsman device 102 by the user is only permitted if an associated condition is met. For example, the use of a craftsman device 102 by a user may only be authorized if the user is wearing protective equipment (for example, safety goggles). If such protective equipment is also visible with a token 100, the processor 106 can search for a communicably coupled token 100 indicating protective equipment and only allow the desired processing task by a user when the presence of protective equipment has been detected by the presence of such a token 100.

As shown in FIG. 1, the craftsman equipment 104 may include a token arrangement 130 comprising a plurality of tokens 100, wherein different ones of the tokens 100 have different degrees of functionality. For example, the tokens 100 of a craftsman equipment 104 may be divided into tokens 100 of a first, second, and third generation. Each token 100 of any generation may thereby fulfill the basic function of a token 100, as described above. Tokens 100 of higher generations may furthermore have additional functions and/or additional convenience, but also support the basic function of a token 100 of the lowest generation. Tokens 100 of all generations may have the same form and may be used for use with any of the craftsman devices 102 of the craftsman equipment 104. In other words, the token arrangement 130 is compatible with respect to different generations of tokens 100. The craftsman devices 102 require no adaptation with respect to their interaction with a token 100 of a respective generation, except that a receiving means 152 is provided for mechanically receiving an associated token 100.

Each of the inserted tokens 100 can, for example, be configured as a plug-in element for insertion into a receiving opening of a craftsman device 102. For example, each token 100 may be formed as a circular disk having a diameter in a range of 2 cm to 4 cm and is therefore convenient for a user to handle and insert into a craftsman device 102 in a space-saving manner. Other shapes of a token 100 are possible, see for example FIG. 3. Furthermore, the mechanical coupling means 110 of each token 100 is configured to detachably couple the token 100 to the craftsman device 102. Thus, a user can use a token 100 (assigned to him, for example) successively in combination with different craftsman devices 102, wherein the selection of an addressed craftsman device 102 can be made by merely mechanically inserting the mechanical coupling means 110 of the token 100 into an associated receiving means 152 of a target craftsman device 102. Thus, the mechanical coupling means 110 of a token 100 serves as a universal electromechanical interface for different craftsman devices 102.

As already mentioned, the token 100 may comprise one or more sensors 112, including the user identification sensor described above. It is alternatively or additionally possible to equip the token 100 with, for example, a gyro sensor, a location sensor and/or a temperature sensor. A gyro sensor can detect, for example, when a craftsman device 102 with a token 100 accommodated therein falls down and is consequently subjected to a shock. In this case, the craftsman device 102 can be switched off as a precaution to prevent injury to a user and damage. A location sensor (for example a GPS sensor) of the token 100 allows the current position of the token 100 together with the craftsman device 102 to be detected. The use of a craftsman device 102 can be restricted (for example in a user profile) to a specific room area (for example a specific construction site), for example to prevent misuse. If a location sensor detects that a craftsman device 102 together with the token 100 is located in a location not authorized for use, the processor 106 of the token 100 can switch off or deactivate the craftsman device 102 to prevent misuse. A temperature sensor of the token 100 can detect the ambient temperature. If a processing task (for example, setting a chemical dowel) is only permitted under certain temperature conditions, operation of the craftsman device 102 can be made impossible for safety reasons if a temperature condition is not met in view of the temperature sensor data detected.

Optionally, the token 100 has a power supply device 116, for example a replaceable battery or a rechargeable battery. The token 100 can then be operated autonomously. Alternatively or additionally, the token 100 may be supplied with electrical power by a power supply device 142 of a craftsman device 102 when the token 100 is received in the receiving means 152.

FIG. 1 further shows that the token 100 can have a communication antenna 114, for example a WLAN antenna. It is also possible and advantageous for reasons of diversity if the token 100 has several communication antennas 114 which, for example, support different communication protocols. For example, a communication antenna 114 may be realized in the form of a planar coil, which is preferably arranged in a surface area of the token 100. A communication antenna 114 may be formed as a transmit/receive antenna. It is also possible to provide a transmitting antenna and a separate receiving antenna, or only one of these antennas.

In addition, the token 100 shown in FIG. 1 has a communication means 118, which can be formed by interaction of the communication antenna 114 with a corresponding part of the processor 106 and optionally with the cryptographic unit 108. The communication means 118 is used for communicating the token 100 with one or more communication nodes via the communication network 120, which may be, for example, the public Internet, an intranet or a mobile network.

For example, the token 100 may communicate via the communication network 120-or directly-with another token 100 of the craftsman equipment 104. This may be done, for example, for the purpose of recognizing the presence of protective equipment equipped with a token 100 (which may be made a condition for enabling the use of a craftsman device 102 for work safety reasons).

Alternatively or additionally, it is possible to form a communicable coupling between the token 100 and an app or other software stored on a portable user terminal 122 via the communication network 120. In the illustrated exemplary embodiment, the user terminal 122 is a mobile device with a user interface with which a user can control and/or monitor the communicably coupled token 100 and/or a craftsman device 102 coupled thereto. By means of the user terminal 122, a user can also control and/or monitor the craftsman equipment 104 from a remote position. For example, a token 100 can connect via an app to the user terminal 122 configured here as a mobile radio device. By means of the user terminal 122, data can be downloaded to the token 100, for example a user profile of a user of the user terminal 122. Furthermore, it is possible for the token 100 to access resources of the user terminal 122 during operation, for example a processor contained therein and/or a camera of the user terminal 122.

For example, a camera included in the user terminal 122 may be used to capture an image of a product package that provides an inference of a consumable material (for example, a type of screw) used for a machining task. This information can be communicated from the user terminal 122 to the token 100 so that control of a craftsman device 102, for example, configured as a cordless screwdriver, to set a corresponding screw can be performed by the token 100 accordingly. In more general terms, for example, an optical detection device, in particular a camera, can be provided on the token 100 and/or on the user terminal 122, which is configured to detect processing information indicative of a processing task to be carried out by means of the craftsman device 102. Advantageously, the processor 106 may be configured to perform the processing task using the detected processing information.

Alternatively or additionally, it is possible to form a communicable coupling between the token 100 and a central control device 124 (for example, for controlling a plurality of craftsman devices 102) via the communication network 120. The central control device 124 may be provided with an access right to a database 132, from which data records can be transmitted to the token 100. Such data records may include, for example, a user profile requested by the token 100, an operational data record for performing a processing task with a craftsman device 102 mechanically coupled to the token 100, etc. Thus, the token 100 can be configured to download a data set by means of the communication means 118 from the central control device 124 or another node of the communication network 120 that is coupled in a communicable manner, in particular a data set defining an operating sequence of the craftsman device 102 and/or a data set defining a user profile of a user of the token 100.

Furthermore, the communicable coupling between the token 100 and the central control device 124 makes it possible to transmit data from the token 100 to the control device 124 for storage in the database 132. Such data may be, for example, tracking data that allows tracking of a craftsman device 102 coupled to a respective token 100. Thus, the token 100 can be configured to upload a data set by means of the communication means 118 to the control device 124 or another node of the communication network 120 that is coupled in a communicable manner, in particular a data set containing operating results and/or operating parameters of an operation of the craftsman device 102.

Finally, it is possible that the token 100 is coupled via the communication network 120 to a reordering device 126 for reordering consumables for operating a craftsman device 102. If a token 100 detects (for example by means of a token's own, for example optical, sensor 112 and/or by means of a camera image of the user terminal 122) that a remaining stock of a certain consumable (for example a certain type of screw for setting into a substrate by means of a craftsman device 102 configured as a cordless screwdriver into which the token 100 is inserted) has fallen below a critical threshold value, the token 100 can inform the reordering device 126 accordingly via the communication network 120 and thereby trigger or initiate a reordering of this consumable. trigger a reorder of this consumable. The reordering device 126 can be a computer, which in turn can be coupled to supplier nodes via the communication network 120 in order to carry out the reordering. A reordering of consumables can thus be triggered by a token 100, for example if it has been detected by means of the token 100 and/or a craftsman device 102, for example by sensors, that a remaining stock of certain consumables has fallen below a predetermined threshold value.

During operation of the craftsman equipment 100, a user of the token 100 can first be identified by means of the sensor 112, which is configured as a fingerprint sensor, for user-related control of a craftsman device 102 by means of a token 100. Then, a mechanical coupling of the mechanical coupling means 110 of the token 100 with the mechanical connection device 152 of the selected craftsman device 102 may be performed. Before or after the mechanical coupling, a personalized authorization profile of the user of the token 100 can be found, for example in one of the memory devices 128, 140. After the mechanical coupling has taken place, the craftsman device 102 can be controlled by means of the processor 106. Advantageously, use of the craftsman device 102 by the user can be permitted, prevented and/or set based on the personalized authorization profile. In particular, the processor 106 can be configured to enable operation of the craftsman device 102 coupled with the token 100 only if a user identification carried out in advance by means of the token 100 has led to the result that an identifying user is authorized to operate the craftsman device 102. Here, the personalized authorization profile may comprise at least one piece of information from a group consisting of a prohibition of use for at least one defined operating mode of the craftsman device 102 based on a user qualification and/or on a physical (for example, a physical limitation) or biological (for example, an advanced age) user characteristic, a user-specific permission of use for at least one defined operating mode of the craftsman device 102, and a condition of use for the use of the craftsman device 102, for example, related to occupational safety. For example, the authorization profile for a specific user may include the information that the user is only capable of using craftsman devices 102 up to a certain weight (for example up to 20 kg) due to his physical constitution (for example due to his age, his height and/or his weight). Furthermore, in such an authorization profile for a particular user, it may be stored for which craftsman devices 102 the user is authorized to operate (for example, a user may only be allowed to use a forklift if the user has a forklift driver's license). Furthermore, it can be stored in a user profile for a specific user and/or for a specific craftsman device 102 which occupational safety equipment (e.g. protective overalls, ear muffs, safety goggles) must be worn by a user in order to be allowed to use a specific craftsman device 102. A user can be denied the use of a craftsman device 102 by the token 100 until the protective work equipment on this user has been recognized (for example by sensors). For example, the work safety equipment can also be equipped with a corresponding token 100, so that the presence of work safety equipment on the user can be verified by token-token communication.

The processor 106 may be configured to allow or disallow a download of a data set (for example, a data sheet), in particular a data set defining an operation of the craftsman device 102, from a communication network 120 when coupled to the craftsman device 102 based on the personalized authorization profile. For example, an optical sensor (in particular, a camera) of the token 100 and/or on a craftsman device 102 may scan a product package of screws to be set in a substrate (for example, a vertical concrete wall) in an operational mode of the craftsman device 102. In this way, for example, it can be detected by sensors that the screws are M8 screws. The token 100 can then perform or initiate a download of a product specification (as a data set defining an operating sequence) corresponding to the sensor-detected product package. Based on the downloaded data set, the processing task can then be executed without errors, namely by controlling the craftsman device 102 by the token 100 using the downloaded data set.

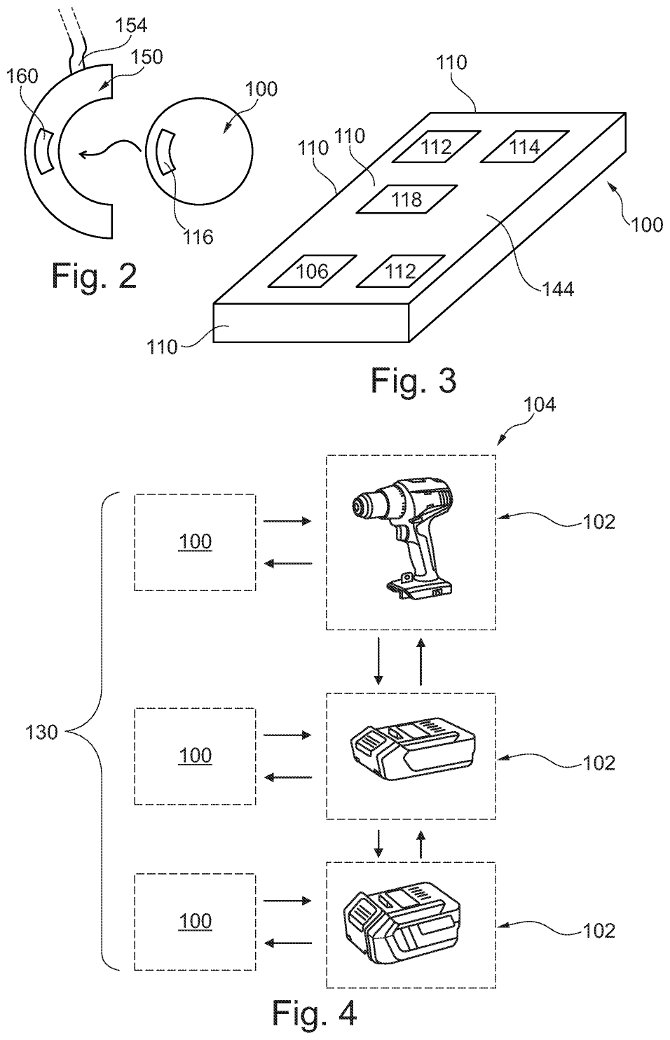

FIG. 2 shows a token 100 with an associated storage and recharging device according to an exemplary embodiment of the invention.

More precisely, the token arrangement shown in FIG. 2 has the token 100 and a token holder 150, which can be configured to hold the token 100 in a form-fit and/or force-fit manner. For this purpose, the token 100 can be clamped in a receiving space of the token holder 150, which is defined between opposing elastic legs of the token holder 150. In this way, a user can store the token 100 in a mechanically protected manner, for example by using a connecting element 154. By means of the connecting element 154, a user can carry the token holder 150, optionally together with the token 100 held therein, in a fixed manner, for example by attaching it to a belt loop.

It is also possible to attach a token 100 with a completely or partially discharged energy supply device 116 (for example a rechargeable battery) to the token holder 150 and thereby trigger a recharging of the energy supply device 116. For this purpose, electrical energy can be transferred (for example by an electrical contact or in an inductive manner) from a charging device 160 of the token holder 150 to the energy supply device 116 of the token 100.

FIG. 3 shows a token 100 according to an exemplary embodiment of the invention. The token 100 according to FIG. 3 is formed as a rectangular strip that can be intuitively inserted into an inversely shaped recess in the interior of a craftsman device 102.

FIG. 4 shows components of a craftsman's equipment 104 according to another exemplary embodiment of the invention.

The craftsman equipment 104 according to FIG. 4 includes, for example, three craftsman devices 102 and, for example, three tokens 100.

The three craftsman devices 102 according to FIG. 4 are configured as a drill (top), sensor module (middle) and battery block (bottom) and can be connected to each other. During operation, the battery block supplies the drilling machine with electrical energy, while the sensor module detects operating data of the drilling machine by sensors (and uses these, for example, as a basis for a control system). Bidirectional signal coupling (i.e. in the direction of transmission and in the direction of reception) is possible between the drilling machine and the sensor module, see the two arrows. Similarly, bidirectional signal coupling is possible between the sensor module and the battery block.

Bidirectional signal coupling is also possible between each of the craftsman devices 102 and a respective one of the tokens 100. The configuration according to FIG. 4 shows that all components 102, 100 can communicate with each other on an equal footing. The communication interfaces between the components 102, 100 can, for example, be configured in accordance with a UART (Universal Asynchronous Receiver Transmitter) protocol.

The illustrated tokens 100 may form a token arrangement 130 of tokens 100 of varying degrees of functionality, wherein any of the tokens 100 of the token arrangement 130 may be mechanically and functionally coupled to any of the craftsman devices 102.

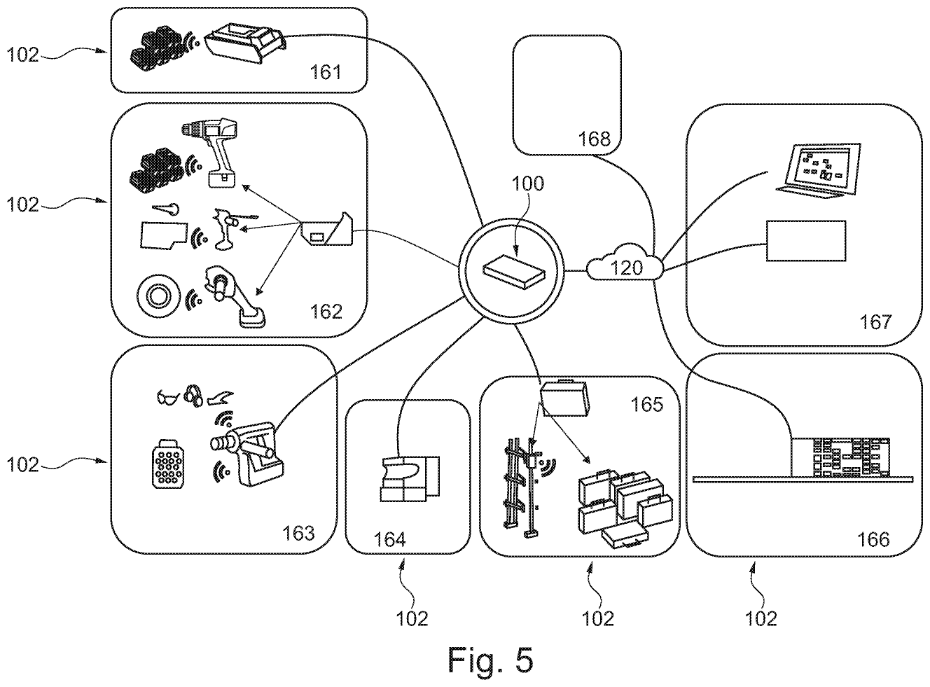

FIG. 5 shows a craftsman equipment 104 with craftsman devices 102 and a token 100 according to an exemplary embodiment of the invention, which are coupled in a communication network 120. FIG. 5 shows a modular craftsman equipment 104 in an Internet of Things (IoT) architecture.

Reference mark 161 shows adapters, reference mark 162 shows hand-held devices, reference mark 163 shows personal protective equipment and wearables, reference mark 164 shows the application of third party craftsman equipment 164, reference mark 165 shows tracker elements, reference mark 166 shows stocking systems, reference mark 167 shows an inventory management system, and reference mark 168 shows an online store. All of these systems may be included in the token-controlled craftsman equipment 104.

According to an exemplary embodiment of the invention, it is also possible to implement a token as a tracker in a craftsman device (for example in a power tool, a battery housing, etc.). This makes it possible to determine the location of the craftsman device. Optionally, at least one sensor or at least one further sensor can also be integrated into the token, for example a temperature sensor and/or a humidity sensor.

In addition, it should be noted that “comprising” does not exclude other elements or steps and “one” or “a” does not exclude a plurality. Furthermore, it should be noted that features or steps described with reference to one of the above embodiments may also be used in combination with other features or steps of other embodiments described above. Reference signs in the claims are not to be regarded as a limitation.

1. A craftsman equipment, comprising:
a plurality of craftsman devices, at least some of which comprise mechanical receiving means for mechanically coupling to a mechanical coupling means of a token; and
the token with a processor and with the mechanical coupling means for selective mechanical coupling with a respective mechanical receiving means of the respective craftsman device;
wherein the craftsman devices comprise at least two different elements from a group consisting of an electrical hand-held device, a tool or tool set, a storage system, a consumable, and a vehicle.

2. The craftsman equipment according to claim 1, comprising at least one further token with a further processor and with a mechanical coupling means for selective mechanical coupling with a respective mechanical receiving means of a respective other craftsman device.

3. The craftsman equipment according to claim 2, wherein the token has a communication means and the at least one further token has at least one further communication means and the tokens are coupled to one another in a communicable manner by means of the communication means, in particular directly or via a node of a communication network.

4. The craftsman equipment according to claim 1, wherein the token is configured to control said craftsman device by means of the processor when mechanically coupling the mechanical coupling means to the mechanical receiving means of the respective craftsman device.

5. The craftsman equipment according to claim 1, wherein the token is formed as a disk, in particular as a circular disk, with a diameter in a range from 1 cm to 10 cm, in particular in a range from 2 cm to 5 cm.

6. The craftsman equipment according to claim 1, wherein the mechanical coupling means is configured to couple the token detachably from the respective craftsman device.

7. The craftsman equipment according to claim 1, comprising at least one of the following features:
wherein the mechanical coupling means has an electromechanical interface, in particular a universal electromechanical interface for different craftsman devices;
wherein the token is configured to simultaneously form a communication connection, in particular a contactless or contact-based communication connection, with a craftsman device when the mechanical coupling means is mechanically coupled to the craftsman device.

8. The craftsman equipment according to claim 1, wherein the token comprises a communication means configured to communicate by means of a communication network, in particular by means of the public Internet, by means of an intranet and/or by means of a mobile network.

9. The craftsman equipment according to claim 8, wherein the token is configured to communicate by means of the communication means with at least one communicably coupled node of the communication network selected from a group consisting of another token, a portable user terminal with an app stored thereon, a central control device, and a reordering device for reordering consumables for operating a craftsman device.

10. The craftsman equipment according to claim 8, wherein the token is configured to download a data set by means of the communication means from a communicatively coupled node of the communication network, in particular a data set defining an operating sequence of the craftsman device and/or a data set defining a user profile of a user of the token.

11. The craftsman equipment according to claim 8, wherein the token is configured to upload a data set by means of the communication means to a communicably coupled node of the communication network, in particular a data set containing operating results and/or operating parameters of an operation of the craftsman device.

12. The craftsman equipment according to claim 1, wherein the processor is configured to control the operation of the craftsman device coupled to the token in accordance with a personalized user profile stored in the token or accessible to the token, in particular in accordance with a personalized user authorization profile, of the user of the token.

13. The craftsman equipment according to claim 12, comprising at least one of the following features:
wherein the processor is configured to permit, set and/or prevent use of the craftsman device by the user based on the personalized authorization profile when coupled with a respective craftsman device;
the token having an identification means for identifying a user of the token, in particular the processor being configured to enable operation of the craftsman device coupled to the token only if a user identification carried out in advance by means of the token has led to the result that an identifying user is authorized to operate the craftsman device.

14. The craftsman equipment according to claim 1, comprising at least one of the following features:
wherein the craftsman devices comprise at least one electric hand-held device, in particular from a group consisting of a drill, a cordless screwdriver, a cordless drill driver, a rotary screwdriver, a pulse screwdriver, a ratchet screwdriver, an impact wrench, in particular a cordless impact wrench, a hammer drill, a corded hand-held device and a compressed air-operated hand-held device;
wherein the tool is configured as a tool from a group consisting of a hammer, pliers, a file, a screwdriver, a drill, a bit and a nut for a ratchet;
wherein the storage system is configured as a storage system from a group consisting of a case, a shelf, a drawer and a box;
wherein the consumable is formed as a consumable from a group consisting of a screw, a dowel, a bolt anchor, a nail, a rivet, and a package containing such consumables;
wherein the vehicle is configured as a vehicle from a group consisting of a vehicle driven by a motor, in particular electrically and/or by means of an internal combustion engine, and a vehicle driven by muscle power;
wherein the craftsman devices comprise at least one electrical hand-held device, at least one tool and/or at least one tool set, at least one storage system, at least one consumable, and at least one vehicle.

15. A method for user-based management of craftsman devices by means of a token of a craftsman equipment according to claim 1, wherein the method comprises:
mechanically coupling the mechanical coupling means of the token to a mechanical receiving means of a selected one of the craftsman devices; and
after mechanical coupling, controlling the coupled craftsman device by means of the processor of the token.
